(19) United States
(12) Patent Application Publication
(10) Pub. No.: US 2010/0035664 A1
(43) Pub. Date: Feb. 11, 2010

(54) SOLAR ENERGY CHARGER AND PORTABLE ELECTRONIC DEVICE EMPLOYING THE SAME

(75) Inventor: XIAO-XU LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/538,244

(22) Filed: Aug. 10, 2009

(30) Foreign Application Priority Data
Aug. 11, 2008 (CN) 200810303645.7

(51) Int. Cl. H04B 1/38; H01M 10/46

(52) U.S. Cl. 455/573; 320/101

(57) ABSTRACT

A solar energy charger includes a solar energy collecting module, a controlling module electrically connected to the solar energy collecting module, an energy storing module electrically connected to the controlling module, and a switching module electrically connected to the controlling module and energy storing module. The energy storing module includes a first energy storing unit and a second energy storing unit. The solar energy collecting module is configured for converting solar energy into electrical energy. The controlling module detects electrical energy states of the energy storing units to output a detecting result, and the controlling module controls and switches the switching module to charge or discharge the energy storing units in turn according to the detecting result.

### BACKGROUND

1. Technical Field

The disclosure relates to solar energy chargers, particularly, to a solar energy charger for a portable electronic device.

2. Description of Related Art

Portable electronic devices, such as mobile telephones and personal digital assistants (PDAs), generally are equipped with chargeable batteries. When electrical energy of the battery is low or empty, a power source is required to charge the battery. However, when power sources are not available, it is hard to charge the battery. It is well known that existing solar energy chargers are used widely to charge the batteries. However, when a solar energy charger is employed to convert solar radiation energy into electrical energy, the electrical energy may not be stable enough to directly charge the battery, and can not be stored in the solar energy charger such that the conversion efficiency and the operating efficiency are low. In addition, when the portable electronic device is in use and charged with unstable electrical energy at the same time, the possibility of damaging inner circuits of the portable electronic device rises.

Therefore, there is a room for improvement within the art.

### BRIEF DESCRIPTION OF THE DRAWINGS

Many aspects of a solar energy charger and a portable electronic device employing the same can be better understood with reference to the following drawings. The components in the drawings are not necessarily to scale, the emphasis instead being placed upon clearly illustrating the principles of the present solar energy charger and a portable electronic device employing the solar energy charger. Moreover, in the drawings, like reference numerals designate corresponding parts throughout the several views.

FIG. 1 is a diagram of a solar energy charger, according to an exemplary embodiment.

FIG. 2 is a diagram of a portable electronic device with the solar energy charger shown in FIG. 1.

### DETAILED DESCRIPTION OF THE EMBODIMENTS

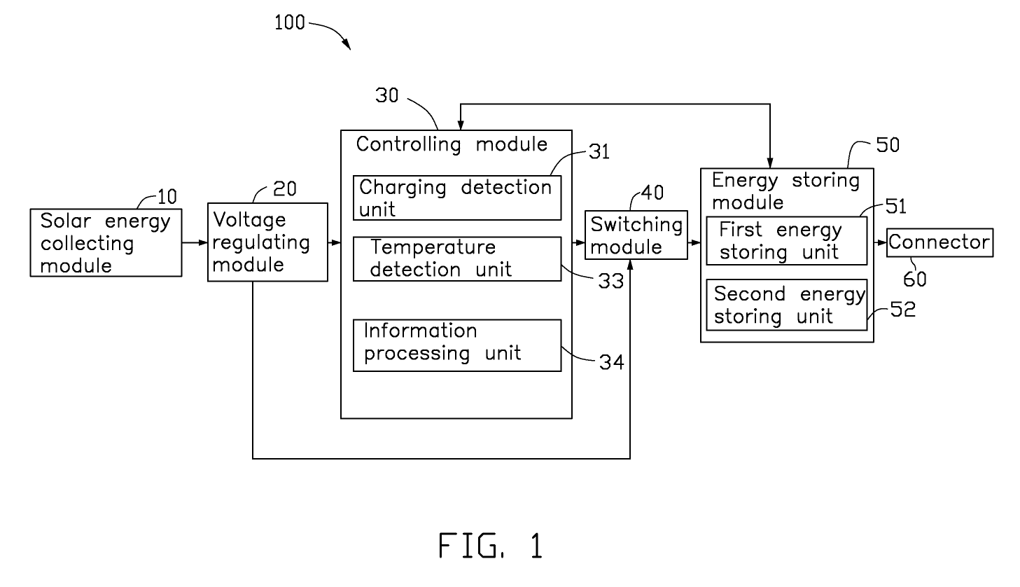

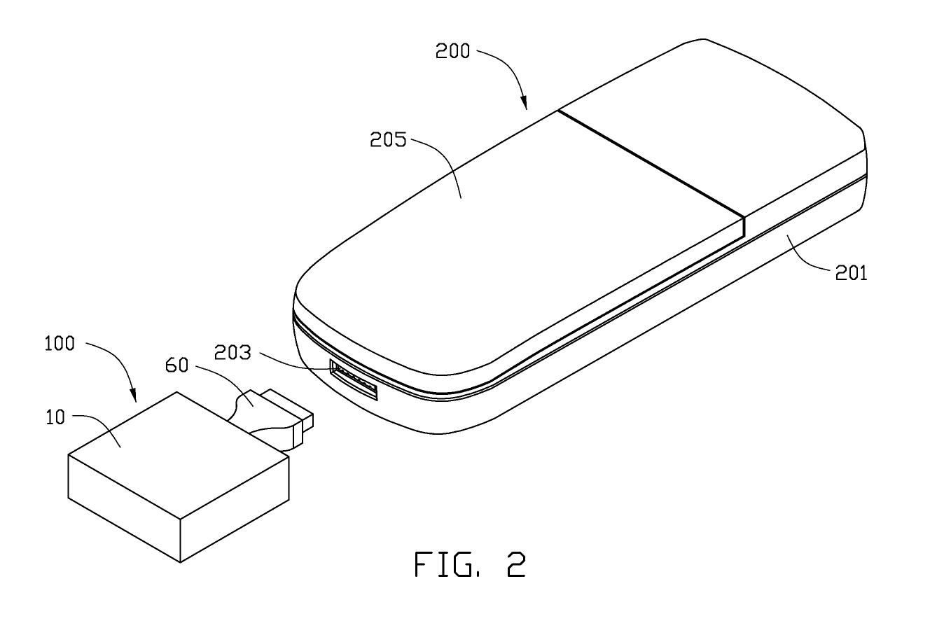

FIGS. 1-2 show an exemplary embodiment of a solar energy charger 100 for use with a portable electronic device 200, such as a mobile phone. The mobile phone is taken here as an exemplary application, for the purposes of describing details of the solar energy charger 100. The portable electronic device 200 includes a housing 201, a charging socket 203, and a battery 205. The charging socket 203 is formed at one end of the housing 201 for electronically connecting with the solar energy charger 100. The battery 205 is mounted in the housing 201 configured for supplying electrical energy to the portable electronic device 200.

Referring to FIG.1, the solar energy charger 100 includes a solar energy collecting module 10, a voltage regulating module 20, a controlling module 30, a switching module 40, an energy storing module 50, and a connector 60, which are electronically connected in series. The voltage regulating module 20 is also electronically connected to the switching module 40, and the controlling module 30 is also electronically connected to the energy storing module 50.

The solar energy collecting module 10 is configured to convert solar energy into electrical energy. The converted energy by the solar energy collecting module 10 may be too unstable to directly charge the battery 205. The voltage regulating module 20 is configured to convert unstable voltage from the solar collecting module 10 into a stable voltage, and the stable voltage is transmitted to the controlling module 30 and the switching module 40. The energy storing module 50 is configured to store the electrical energy. The energy storing module 50 includes a first energy storing unit 51 and a second energy storing unit 52, both capable of storing electrical energy. The connector 60 is configured to engage with the charging socket 203 of the portable electronic device 200 to charge the battery 205.

The controlling module 30 includes a charging detection unit 31, a temperature detection unit 33, and an information processing unit 34. The charging detection unit 31 is configured to detect power state of the energy storing units 51 and 52, and output a detecting signal according to the detecting result. The information processing unit 34 receives the detecting signal from the charging detection unit 31 and controls the switching module 40 to switch between a charging state or discharging state according to the detecting signal. For example, when the charging detection unit 31 detects that the first energy storing unit 51 is in a fully charged state, then the information processing unit 34 controls and switches the switching module 40 to charge the second energy storing unit 52. The temperature detection unit 33 is configured to detect temperatures of the energy storing units 51 and 52. When the temperature of one of the energy storing units 51 and 52 rises rapidly due to abnormal conditions, the information processing unit 34 controls and turns the switching module 40 off, thereby stopping charging the energy storing module 50.

In use, the connector 60 is electrically connected to the charging socket 203 of the portable electronic device 200 to charge the battery 205. The solar energy collecting module 10 receives and converts solar energy into electrical energy, the voltage regulating module 20 converts the unstable voltage from the solar energy collecting module 10 into a stable voltage to protect and charge the energy storing units 51 and 52. Thus, when the electrical energy of the energy storing units 51 and 52 are in the an exhausted state, the information processing unit 34 controls and switches the switching module 40 to charge the first energy storing unit 51. When both the first energy storing unit 51 and the second energy storing unit 52 are in the fully charged state, the information processing unit 34 controls and switches the switching module 40 to stop charging the energy storing units 51 and 52. Therefore, the energy storing units 51 and 52 can work as energy source to charge the battery 205 via the connector 60.

The energy storing units 51 and 52 can charge the battery 205 in turn. When the charging detection unit 31 detects the electrical energy of the first energy storing unit 51 is low or empty, the information processing unit 31 controls the second storing unit 52 to continue charging the battery 205 via the connector 60. Then the first energy storing unit 51 is charged by the electrical energy from the voltage regulating module 20. When the temperature of one of the energy storing unit 51 and 52 rises rapidly due to abnormal conditions, the information processing units 34 controls and turns the switching module 40 off, thereby stopping charging the energy storing module 50.

Understandably, the amount of the energy storing units of the energy storing module 50 are not just limited to two, can also be more than two.

It is understood that the battery 205 of the portable electronic device 200 can be mounted into the energy storing module 50 and work as the energy storing unit 51 or 52 to supply the electrical energy to the portable electronic device 200.

The controlling module 30 can control the first energy storing unit 51 and second energy storing unit 52 to charge the battery 205 in turn via switching the switching module 40. The energy storing units 51 or 52 in fully charged state can charge the battery 205 of the portable electronic device 200, and the energy storing units 51 or 52 in an exhausted state can receive electrical energy from the voltage regulating module 20 at the same time. Therefore, the solar energy charger 100 can charge the battery 205 via the connector 60 and store the electrical energy at the same time to improve the efficiency of the solar energy.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A solar energy charger, comprising:
a solar energy collecting module configured for converting solar energy into electrical energy;
a controlling module electrically connected to the solar energy collecting module;
a switching module electrically connected to the controlling module, and controlled by the controlling module to switch; and
an energy storing module electrically connected to the controlling module and the switching module, the energy storing module including a first energy storing unit and a second energy storing unit configured for storing electrical energy;
wherein the controlling module detects electrical energy states of the energy storing units to form a detecting result, and controls and switches the switching module to charge or discharge the energy storing units in turn according to the detecting result.

2. The solar energy charger as claimed in claim 1, wherein when the controlling module detects one of the energy storing units is in fully charged state, the controlling module controls and switches the switching module to discharge the energy storing unit in the fully charged state, and charge another energy storing unit.

3. The solar energy charger as claimed in claim 1, wherein when the controlling module detects one of the energy storing units is in an exhausted state, the controlling module controls and switches the switching module to charge the energy storing unit in the exhausted state.

4. The solar energy charger as claimed in claim 1 further including a voltage regulating module electrically connected to the solar energy collecting module, the controlling module and the switching module, wherein the voltage regulating module is configured for converting an unstable voltage into a stable voltage to charge the first energy storing unit and the second energy storing unit.

5. The solar energy charger as claimed in claim 1, further including a connector electrically connected with the energy storing module and configured for outputting electrical energy.

6. The solar energy charger as claimed in claim 1, wherein the controlling module includes a charging detection unit configured for detecting the electrical energy states of the first energy storing unit and the second energy storing unit.

7. The solar energy charger as claimed in claim 6, wherein the controlling module further includes a temperature detecting module configured to detect temperatures of the energy storing units.

8. The solar energy charger as claimed in claim 7, wherein the controlling module further includes an information processing unit configured to control and switch the switching module to charge the energy storing module or not.

9. A portable electronic device, comprising:
a housing;
a charging socket formed at one end of the housing; and
a solar energy charger mounted to the portable electronic device, electrically connected with the charging socket and charging the portable electronic device, the solar energy charger comprising:
a solar energy collecting module configured for converting solar energy into electrical energy;
a controlling module electrically connected to the solar energy collecting module;
a switching module electrically connected to the controlling module, and controlled by the controlling module to switch; and
an energy storing module electrically connected to the controlling module and the switching module, the energy storing module including a first energy storing unit and a second energy storing unit, and configured for storing electrical energy;
wherein the controlling module detects electrical energy states of the energy storing units to form a detecting result, and controls and switches the switching module to charge or discharge the energy storing units in turn according to the detecting result, then one of the energy storing units is used to charge the battery.

10. The portable electronic device as claimed in claim 9, wherein when the controlling module detects one of the energy storing units is in fully charged state, the controlling module controls and switches the switching module to discharge this energy storing unit in the fully charged state, and charge another energy storing unit.

11. The portable electronic device as claimed in claim 9, wherein when the controlling module detects one of the energy storing units is in an exhausted state, the controlling module controls and switches the switching module to charge the energy storing unit in the exhausted state.

12. The portable electronic device as claimed in claim 9, wherein the solar energy charger further includes a voltage regulating module electrically connected to the solar energy collecting module, the controlling module and the switching module, the voltage regulating module is configured for converting an unstable voltage into a stable voltage to charge the first energy storing unit and the second energy storing unit.

13. The portable electronic device as claimed in claim 9, wherein the solar energy charger further includes a connector electrically connected with the energy storing module, and configured for outputting electrical energy.

14. The portable electronic device as claimed in claim 9, wherein the controlling module includes a charging detection unit configured for detecting the electrical energy states of the first energy storing unit and the second energy storing unit.

15. The portable electronic device as claimed in claim 14, wherein the controlling module further includes a temperature detecting module configured to detect temperatures of the energy storing units.

16. The portable electronic device as claimed in claim 15, wherein the controlling module further includes an information processing unit configured to control and switch the switching module to charge the energy storing module or not.

17. A portable electronic device, comprising:
a housing;
a charging socket formed at one end of the housing;
a battery mounted in the housing and electrical energy for the portable electronic device; and
a solar energy charger mounted to the housing and charging the portable electronic device via the charging socket, the solar energy charger comprising:
a solar energy collecting module configured for converting solar energy into electrical energy;
a controlling module electrically connected to the solar energy collecting module;
a switching module electrically connected to the controlling module, and controlled by the controlling module to switch; and
an energy storing module electrically connected to the controlling module and the switching module, the energy storing module including a first energy storing unit and a second energy storing unit, and configured for storing electrical energy;
wherein the controlling module detects electrical energy states of the energy storing units to form a detecting result, and controls and switches the switching module to charge or discharge the energy storing units in turn according to the detecting result, then one of the energy storing units is used to charge the battery.

18. The portable electronic device as claimed in claim 17, wherein the solar energy charger further includes a voltage regulating module electrically connected to the solar energy collecting module, the controlling module and the switching module, the voltage regulating module is configured for converting an unstable voltage into a stable voltage to charge the first energy storing unit and the second energy storing unit.

19. The portable electronic device as claimed in claim 17, wherein the solar energy charger further includes a connector electrically connected with the energy storing module, and configured for outputting electrical energy.

20. The portable electronic device as claimed in claim 17, wherein the controlling module includes a charging detection unit, a temperature detecting unit, and an information processing unit, the controlling unit is configured for detecting the electrical energy states of the first energy storing unit and the second energy storing unit, the temperature detecting unit is configured to detect temperatures of the energy storing units, and the information processing unit is configured to control and switch the switching module to charge the energy storing module or not.
